(19) United States
(12) Patent Application Publication
(10) Pub. No.: US 2012/0195474 A1
(43) Pub. Date: Aug. 2, 2012

(54) METHOD AND APPARATUS FOR EVALUATING HUMAN POSE RECOGNITION TECHNOLOGY

(75) Inventors: Liang LI, Beijing (CN); Weiguo Wu, Beijing (CN)

(73) Assignee: Sony Corporation, Tokyo (JP)

(21) Appl. No.: 13/362,236

(22) Filed: Jan. 31, 2012

(30) Foreign Application Priority Data
Jan. 31, 2011 (CN) 201110036065.8

(51) Int. Cl. G06K 9/62

(52) U.S. Cl. 382/115

(57) ABSTRACT

A method and apparatus for evaluating a human pose recognition technology, where this method comprises: a loading step of loading a pose recognition module with the human pose recognition technology to be evaluated; a pose recognizing step of recognizing a human pose for each test image in a test image set using the pose recognition module to obtain pose data for each test image; a pose classifying step of classifying the pose data for each test image in terms of a predetermined pose category set to obtain a pose category value for each test image; a pose classification evaluating step of calculating a pose classification accuracy rate by comparing the pose category value for each test image with a pose category true value; and a pose recognition comprehensive evaluating step of calculating a comprehensive evaluation score for the human pose recognition technology according to the pose classification accuracy rate.

### FIELD OF THE INVENTION

The present invention relates to the fields of computer vision and artificial intelligence, and more particularly, to a method and apparatus for evaluating human pose recognition technology.

### BACKGROUND OF THE INVENTION

Identifying a human three-dimensional pose from a two-dimensional image is a hot issue in the fields of computer vision and artificial intelligence, and this technology may be applicable for areas such as human-computer interaction, video monitoring and analysis and comprehension of digital information. However, this problem is also a challenging difficult problem at present for the following reasons: 1) loss of depth information in a two-dimensional image causes uncertainty of inferring three-dimensional information from a two dimensional image, that is, there may be several possible solutions; and 2) the human image has factors such as background change, light change, clothing change, different view angle sand different pose that greatly affect the inference of three-dimensional pose.

At present, methods for evaluating a recognition result of three-dimensional pose recognition technology mostly measure a distance or error between pose estimation result and pose true value, the smaller the distance or error is, the higher the comprehensive evaluation scores. Where, the result of pose estimation may be three-dimensional XYZ coordinate values (for example, see non-patent documents 1, 2 and 4), or three-dimensional rotation angle values (for example see patent documents 2 and 3), so the method for evaluating those pose recognition technologies is to measure an error between the XYZ coordinate values or rotation angle values and the target true value. However, this evaluation method cannot intuitively reflect pros and cons of the technology per se, and especially from the technology application point of view, error magnitude of the pose evaluation result cannot be connected directly to availability and robustness of the technology, and thus cannot reflect practical degree of the technology.
[non-patent document 1] Ankur Agarwal, et al, “A Local Basis Representation for Estimating Human Pose from Cluttered Images”, ACCV'06.
[non-patent document 2] Ben Daubney, et al, “Real-Time Pose Estimation of Articulated Objects using Low-level Motion”, CVPR'08.
[non-patent document 3] Alessandro Bissacco, et al, “Fast Human Pose Estimation using Appearance and Motion vis Multi-Dimensional Boosting Regression”, ICCV'07
[non-patent document 4] Alireza Fathi, Greg Mori, “Human Pose Estimation using Motion Exemplars”, ICCV'07.

### SUMMARY OF THE INVENTION

A brief summary of the present invention is given hereinafter to provide basic understandings related to some aspects of the present invention. However, it shall be understood that this summary is not an exhaustive summary related to the present invention. The summary is not intended to determine a key part or an important part of the present invention, nor does it intend to limit the scope of the present invention. The purpose of the summary is only to provide some concepts in simplified forms to prelude more detailed descriptions discussed later.

In view of the above cases of the existing technology, an object of the invention is to provide a method and apparatus for evaluating human pose recognition technology, which can solve or mitigate one or more problems of the existing technical.

To achieve the above object, according to one aspect of the invention, there is provided a method for evaluating a human pose recognition technology, using a processor, the method including the steps of: a loading step of loading a pose recognition module with human pose recognition technology to be evaluated; a pose recognizing step of recognizing a human pose for each test image in a test image set using the pose recognition module, so as to obtain pose data for each test image; a pose classifying step of classifying pose data for each test image obtained in the pose recognizing step in terms of a predetermined pose category set composed of a plurality of predetermined pose categories, so as to obtain a pose category value for each test image; a pose classification evaluating step of calculating a pose classification accuracy rate by comparing pose category value for each test image obtained in the pose classifying step with a corresponding pose category true value; and a pose recognition comprehensive evaluating step of calculating a comprehensive evaluation score for the human pose recognition technology, according to the pose classification accuracy rate calculated in the pose classification evaluating step.

According to another aspect of the invention, there is further provided a method for evaluating a human pose recognition technology using a processor, the method including the steps of: a loading step of loading a pose recognition module with the human pose recognition technology to be evaluated; a pose recognizing step of recognizing a human pose for each test image in a test image set using the pose recognition module so as to obtain pose data for each test image; a pose classifying step of classifying the pose data in terms of a predetermined pose category set composed of a plurality of predetermined pose categories so as to obtain a pose category value for each test image; a pose classification evaluating step of calculating a pose classification accuracy rate according to manual judging results of whether the pose category value for each test image obtained in the pose classifying step is correct; and a pose recognition comprehensive evaluating step of calculating a comprehensive evaluation score for the human pose recognition technology, according to the pose classification accuracy rate obtained in the pose classification evaluating step.

According to another aspect of the invention, there is further provided an apparatus for evaluating a human pose recognition technology including: a loading unit configured to load a pose recognition module with the human pose recognition technology to be evaluated; a pose recognition unit configured to recognize a human pose for each test image in a test image set using the pose recognition module so as to obtain pose data for each test image; a pose classification unit configured to classify pose data for each test image obtained by the pose recognition unit in terms of a predetermined pose category set composed of a plurality of predetermined pose categories so as to obtain a pose category value for each test image; a pose classification evaluation unit configured to calculate a pose classification accuracy rate by comparing the pose category value for each test image obtained by the pose classification unit with a corresponding pose category true value; and a pose recognition comprehensive evaluation unit configured to calculate a comprehensive evaluation score for the human pose recognition technology, according to the pose classification accuracy rate calculated by the pose classification evaluation unit.

According to another aspect of the invention, there is further provided an apparatus for evaluating a human pose recognition technology including: a loading unit configured to load a pose recognition module with the human pose recognition technology to be evaluated; a pose recognition unit configured to recognize a human pose for each test image in a test image set using the pose recognition module so as to obtain pose data for each test image; a pose classification unit configured to classify the pose data in terms of a predetermined pose category set composed of a plurality of predetermined pose categories so as to obtain a pose category value for each test image; a pose classification evaluation unit configured to calculate a pose classification accuracy rate according to manual judging results of whether the pose category value for each test image obtained by the pose classification unit is correct; and a pose recognition comprehensive evaluation unit configured to calculate a comprehensive evaluation score for the human pose recognition technology, according to the pose classification accuracy rate obtained by the pose classification evaluation unit.

According to another aspect of the invention, there is further provided a computer system for evaluating a human pose recognition technology including: an input device configured to input a test image set; and a processing device which is coupled to the input device and comprises: a loading unit configured to load a pose recognition module with the human pose recognition technology to be evaluated; a pose recognition unit configured to recognize a human pose for each test image in the test image set using the pose recognition module so as to obtain pose data for each test image; a pose classification unit configured to classify the pose data for each test image obtained by the pose recognition unit in terms of a predetermined pose category set composed of a plurality of predetermined pose categories so as to obtain a pose category value for each test image; a pose classification evaluation unit configured to calculate a pose classification accuracy rate by comparing the pose category value for each test image obtained by the pose classification unit with a corresponding pose category true value; and a pose recognition comprehensive evaluation unit configured to calculate a comprehensive evaluation score for the human pose recognition technology, according to the pose classification accuracy rate calculated by the pose classification evaluation unit.

According to another aspect of the invention, there is further provided a computer system for evaluating a human pose recognition technology including: an input device configured to input a test image set; and a process device which is coupled to the input device and comprises: a loading unit configured to load a pose recognition module with the human pose recognition technology to be evaluated; a pose recognition unit configured to recognize a human pose for each test image in the test image set using the pose recognition module so as to obtain pose data for each test image; a pose classification unit configured to classify the pose data for each test image obtained by the pose recognition unit in terms of a predetermined pose category set composed of a plurality of predetermined pose categories so as to obtain a pose category value for each test image; a pose classification evaluation unit configured to calculate a pose classification accuracy rate according to manual judging results of whether the pose category value for each test image obtained by the pose classification unit is correct; and a pose recognition comprehensive evaluation unit configured to calculate a comprehensive evaluation score for the human pose recognition technology, according to the pose classification accuracy rate obtained by the pose classification evaluation unit.

According to another aspect of the invention, there is further provided a computer program product for implementing the method for evaluating a human pose recognition technology.

According to yet another aspect of the invention, there is further provided a computer-readable medium on which computer program codes for implementing the method for evaluating a human pose recognition technology described above are recorded.

According to the above technical solutions of the invention, the effect of a human pose recognition technology can be evaluated according to a precision of pose classification, thus better applicability and practicability may be realized.

### BRIEF DESCRIPTION OF THE DRAWINGS

The invention can be better understood with reference to the detailed description given below in conjunction with the accompanying drawings, throughout which identical or similar components are denoted by identical or similar reference signs, and together with which the following detailed description are incorporated into and form a part of the specification and serve to further illustrate preferred embodiments of the invention and to explain principles and advantages of the invention. In the drawings:

FIG. 1 illustrates a flowchart of a method for evaluating a human pose recognition technology according to an embodiment of the invention;

FIG. 2 illustrates an example of a typical pose image set;

FIG. 3 illustrates a flowchart of a method for evaluating a human pose recognition technology according to another embodiment of the invention;

FIG. 4 illustrates a structural block diagram of an apparatus for evaluating a human pose recognition technology according to an embodiment of the invention;

FIG. 5 illustrates a structural block diagram of an apparatus for evaluating a human pose recognition technology according to another embodiment of the invention;

FIG. 6 illustrates a structural block diagram of a computer system for evaluating a human pose recognition technology according to an embodiment of the invention;

FIG. 7 illustrates a structural block diagram of a computer system for evaluating a human pose recognition technology according to another embodiment of the invention; and

FIG. 8 illustrates an exemplary structural block diagram of a computer implementing the invention.

Those in the art shall appreciate that elements in the Figures are illustrated merely for simplicity and clarity and are not necessarily drawn in proportion. For example, the dimensions of some of elements in the Figures may be enlarged relative to other elements so as to improve understanding of the embodiments of the invention.

### DETAILED DESCRIPTION OF THE INVENTION

Exemplary embodiments of the present invention will be described in conjunction with the accompanying drawings hereinafter. For the sake of clarity and conciseness, not all the features of actual implementations are described in the specification. However, it shall be appreciated that, during developing any of such actual implementations, numerous implementation-specific decisions must be made to achieve the developer's specific goals, for example, compliance with system-related and business-related constraints which will vary from one implementation to another. Moreover, it is also to be appreciated that, such a development effort might be very complex and time-consuming, but may nevertheless be a routine task for those skilled in the art having the benefit of this disclosure.

It shall further be noted that only those apparatus structures and/or processing steps closely relevant to solutions of the invention will be illustrated in the drawings while omitting other details less relevant to the invention so as not to obscure the invention due to those unnecessary details.

It is indicated first that in the context, a test image refers to a human image containing a human pose, and may be a still image such as a picture or a dynamic image such as a video.

A method for evaluating a human pose recognition technology according to an embodiment of the invention will be described in detail hereinafter with reference to the drawings.

In the embodiment, an input test image has a target true value of a human pose, and the target true value includes a pose data true value and a pose category true value. The target true value is generally obtained by means of an external device, such as a motion capturing system based on optical or mechanical sensors.

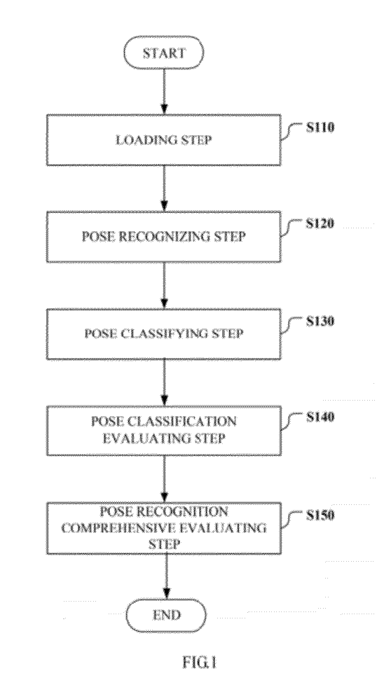

FIG. 1 illustrates a flowchart of a method for evaluating a human pose recognition technology according to an embodiment of the invention.

As shown in FIG. 1, the method for evaluating a human pose recognition technology according to an embodiment of the invention includes a loading step S110, a pose recognizing step S120, a pose classifying step S130, a pose classification evaluating step S140 and a pose recognition comprehensive evaluating step S150.

At first, at the loading step S110, loading a pose recognition module with the human pose recognition technology to be evaluated.

Here, in a case that an interface of the human pose recognition technology to be evaluated is inconsistent with a predetermined interface of the pose recognition module, for example, the format of an input image required by the human pose recognition technology to be evaluated is different from that required by the pose recognition module, or the type of pose data output from the human pose recognition technology to be evaluated is inconsistent with that output from the pose recognition module, the human pose recognition technology to be evaluated may be encapsulated into the pose recognition module with the predetermined interface. Assuming that the input of the pose recognition module is an image I, the output is pose data P=(p₁, p₂, . . . , p_{d}), P is d-dimensional real vector. In one example, the pose data include (x, y, z) XYZ coordinates of 8 joints, that is, eight body joints: head, waist, left shoulder, left elbow, left wrist, right shoulder, right elbow, right wrist, so d=24, that is, the pose data may be represented as P=(x₁, y₁, z₁, x₂, y₂, z₂, . . . , x₈, y₈, z₈). However, a person skilled in the art shall be appreciated that the pose data output from the pose recognition module is not limited to the above XYZ three-dimensional Cartesian coordinate values, and may also be XY two-dimensional image coordinate values, three-dimensional polar angle value, etc. In addition, pose data output from the pose recognition module is not limited to the above 8 body joints, and may relate to more or less body joints based on specific applications.

Next, at the pose recognizing step S120, a human pose is recognized for each test image in a test image set using the loaded pose recognition module, so as to obtain pose data for each test image. Here, assuming that pose data for each test image in the test image set is Res_P={Res_P¹, Res_P², . . . , Res_P^{N}}, where Res_Pⁱ=(res_p₁, res_p₂, . . . , res_p_{d}), N is the number of image in the test image set, i is an index value of a test image in the test image set, which satisfies 1≦i≦N.

Next, at the pose classifying step S130, the pose data for each test image is classified in terms of a predetermined pose category set composed of a plurality of predetermined pose categories, so as to obtain a pose category value for each test image.

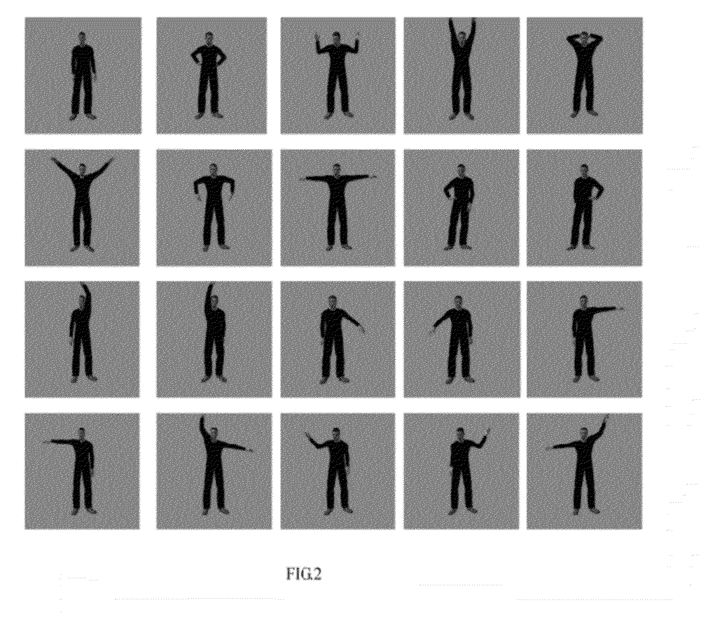

Here, the predetermined pose category set may comprise a predetermined number of arbitrary human poses or a predetermined number of typical human poses, where the typical human poses may be different depending on different application fields. FIG. 2 shows one example of the typical human poses.

In one exemplary implementation, assuming that the predetermined pose category set is Typical_C_P=(T_P₁, T_P₂, . . . , T_Pₘ), where T_P is representative of pose data for each predetermined pose category in the predetermined pose category set, m is the number of the pose category in the predetermined pose category set, each predetermined pose category is given a label (c₁, c₂, . . . , cₘ), then the category label set of the predetermined pose category set is defined as Typical_C=(c₀, c₁, c₂, . . . , cₘ), where c₀ is representative of pose data for a non-predetermined-pos-category, the classifying method is specifically as follows:
1) Calculating pose distances between Res_P and respective predetermined pose categories in the predetermined pose category set Typical_C_P, the pose distance here being defined as mean square deviation of the pose data, that is:

Dist={∥Res_{—}P−T_{—}P₁∥₂, ∥Res_{—}P−T_{—}P₂∥₂, . . . , ∥Res_{—}P−T_{—}Pₘ∥₂}

where

$${‖ Res\_P - {T\_P}_{i} ‖}_{2} = \sqrt[2]{{\sum }_{i = 1}^{d} {( {res\_p}_{1} - {t\_p}_{i} )}^{2}} .$$

2) Searching for a minimum distance dist_min from the distance set, that is: dist_min=Min(Dist).
3) Giving pose category of the current pose data according to the value of the minimum distance based on the following:

$$Res\_C = \{ \begin{matrix}{c}_{0} , IF & dist\_min > {TH}_{class} \\ {c}_{i} = {argmin}_{i} ( {Dist}^{1} ) , & ELSE ,\end{matrix}$$

where TH_{class} is a predetermined classifying distance threshold, in this example, it takes empirical value 5.0.

In another exemplary implementation, assuming that a category label set of the predetermined pose category set is defined as Typical_C=(c₀, c₁, c₂, . . . , cₘ), where c₀ is representative of pose data for a non-predetermined-pose-category. As to each predetermined pose category cᵢ,i=1, 2, . . . , m in the predetermined pose category label set (c₁, c₂, . . . , cₘ), there is a pose data set Typical_C_Pᵢ=(T_P¹, T_P², . . . , T_P^{L}), i=1, 2, . . . , m, where T_P is representative of different pose data for the same predetermined pose category cᵢ, L is representative of the number of the pose data. The pose data set of all pose categories is: Typical_C_P_M=(Typical_C_P₁, Typical_C_P₂, . . . , Typical_C_Pₘ). The classifying method is specifically as follows:

1) Calculating pose distances between Res_P and respective pose data in pose data set Typical_C_Pᵢ=(T_P¹, T_P², . . . , T_P^{k}), i=1, 2, . . . , m of each predetermined pose category in the predetermined pose category set Typical_C_P_M, the pose distance here being defined as mean square deviation of the pose data, that is:

Distᵢ={∥Res_{—}P−T_{—}P¹∥₂, ∥Res_{—}P−T_{—}P²∥₂, . . . , ∥Res_{—}P−T_{—}P^{K}∥₂}, i=1, 2, . . . , m

2) Calculating the number kᵢ of distances which are smaller than a predetermined classifying distance threshold in the pose distance set Distᵢ, i=1, 2, . . . , m for each predetermined pose category, that is:

$${k}_{i} = {\sum }_{j = 1}^{L} sign ( {‖ Res\_P - {T\_P}^{j} ‖}_{2} , {TH}_{class} ) , where$$

$$Sign ( a , b ) = \{ \begin{matrix}1 , & IF a < b \\ 0 , & ELSE\end{matrix}$$

3) Giving the pose category Res_C of current pose data according to the maximum number that the distance is smaller than the predetermined classifying distance threshold in the pose distance set for each predetermined pose category based on the following:

$$Res\_C = \{ \begin{matrix}{c}_{0} , IF & {k}_{i} = 0 \\ {c}_{i} = {argmax}_{i} ( {k}_{i} ) , & ELSE\end{matrix}$$

Next, at the pose classification evaluating step S140, a pose classification accuracy rate is calculated by comparing pose category value for each test image obtained in the pose classifying step S130 with a corresponding pose category true value. Here, assuming that pose category true value for each test image in test image set is Obj_C={Obj_c¹, Obj_c², . . . , Obj_c^{N}}, one exemplary implementation is as follows:

1) Setting the correct pose classifying number Pos_N to be 0.

2) Comparing whether pose category value Res_C for each test image is the same as the corresponding pose category true value Obj_C, if the two categories are the same, add 1 to the correct pose classifying number Pos_N.

Calculating the pose classification accuracy rate

$${Accuracy}^{1} = \frac{Pos\_N}{N} .$$

At last, at the pose recognition comprehensive evaluating step S150, a comprehensive evaluation score for the human pose recognition technology to be evaluated is calculated, according to the pose classification accuracy rate obtained in the pose classification evaluating step S140. Here, in one exemplary implementation, the pose classification accuracy rate may be regarded directly as the comprehensive evaluation score for the human pose recognition technology to be evaluated.

Preferably, the method according to the embodiment may further comprise pose recognition evaluating step (not shown), at the pose recognition evaluating step, a pose recognition accuracy rate is calculated according to the pose data for each test image obtained at the pose recognizing step S120 and the corresponding pose data true value, and at the pose recognition comprehensive evaluating step S150, the comprehensive evaluation score is calculated for the human pose recognition technology to be evaluated according to the pose classification accuracy rate and the pose recognition accuracy rate.

Specifically, assuming that the pose data true value for each test image in the test image set is Obj_P={Obj_P¹, Obj_P², . . . , Obj_P^{N}}, one exemplary implementation of the pose recognition evaluating step is as follows:

1) Calculating pose distances between pose data Res_P for each test image and the corresponding pose data true value Obj_P, the pose distance here being defined as average Euclidean distance Pt_Dist_mean, minimum Euclidean and Pt_Dist_min maximum Euclidean distance Pt_Dist_max of corresponding joint points, where, the calculating method is as follows:

$$Pt\_Dist \_mean = \frac{{\sum }_{i = 1}^{8} \sqrt[2]{{( {res\_x}_{i} - {obj\_x}_{i} )}^{2} + {( {res\_y}_{i} - {obj\_y}_{i} )}^{2} + {( {res\_z}_{i} - {obj\_z}_{i} )}^{2}}}{8}$$

$$Pt\_Dist \_min = {argmin}_{i} ( \sqrt[2]{{( {res\_x}_{i} - {obj\_x}_{i} )}^{2} + {( {res\_y}_{i} - {obj\_y}_{i} )}^{2} + {( {res\_z}_{i} - {obj\_z}_{i} )}^{2}} )$$

$$Pt\_Dist \_max = {argmin}_{i} ( \sqrt[2]{\begin{matrix}{( {res\_x}_{i} - {obj\_x}_{i} )}^{2} + \\ {( {res\_y}_{i} - {obj\_y}_{i} )}^{2} + {( {res\_z}_{i} - {obj\_z}_{i} )}^{2}\end{matrix}} )$$

2) Calculating average distance of all test images in the test image set, that is,

$$Pt\_Dist \_Mean = \frac{{\sum }_{i = 1}^{N} Pt\_Dist {\_mean}_{i}^{2}}{N }$$

$$Pt\_Dist \_Min = \frac{{\sum }_{i = 1}^{N} Pt\_Dist {\_min}_{i}^{2}}{N}$$

$$Pt\_Dist \_Max = \frac{{\sum }_{i = 1}^{N} Pt\_Dist {\_max}_{i}^{2}}{N}$$

3) Calculating pose recognition accuracy rate, the calculating method being as follows:

$${Accuracy}^{2} = \frac{α \cdot Pt\_Dist \_Mean + β \cdot Pt\_Dist \_Min + γ \cdot Pt\_Dist \_Max}{3 \cdot Body\_Height}$$

where α, β, γ are weights of three distances, respectively, in this example, α=0.8, β=0.1, γ=0.1, Body_Height is the human height in the pose data, and in this example, Body_Height=100.0.

In one exemplary implementation, a comprehensive evaluation score for the human pose recognition technology to be evaluated calculated at the pose recognition comprehensive evaluating step S150 is Score=μ·Accuracy¹+ν·Accuracy², where μ,ν are representative of weights of two types of accuracy rates, and in this example, μ=0.5, ν=0.5

According to the preferred implementation solution, on the basis of keeping the existing evaluation of pose recognition error, pose classification is added in view of the technical application to evaluate recognition of pose recognition technology and the accuracy and robustness of the classification, thereby reflecting more directly the pros and cons of the technology.

The method for evaluating a human pose recognition technology according to another embodiment of the invention is described in detail with reference to the drawings.

In this embodiment, the input test image has no target true value of human pose.

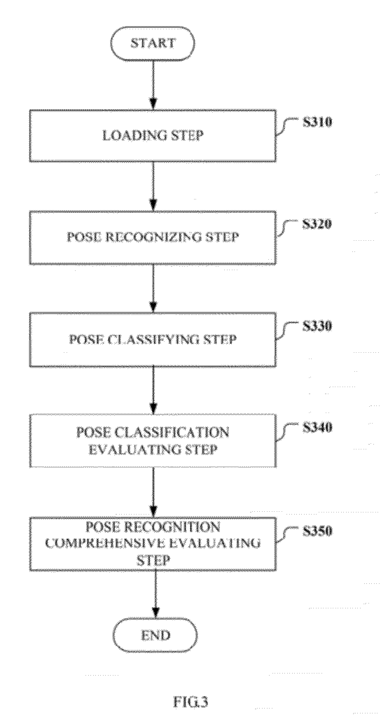

As shown in FIG. 3, the method for evaluating a human pose recognition technology according to another embodiment of the invention includes a loading step S310, a pose recognizing step S320, a pose classifying step S330, a pose classification evaluating step S340 and a pose recognition comprehensive evaluating step S350, where processes in the loading step S310, the pose recognizing step S320, and the pose classifying step S330 are the same as those in the loading step S110, the pose recognizing step S120, and the pose classifying step S130 shown in FIG. 1, and the descriptions thereof are omitted herein.

At the pose classification evaluating step S340, a pose classification accuracy rate is calculated according to manual judging results of whether the pose category value for each test image obtained in the pose classifying step S330 is correct.

In one exemplary implementation, the predetermined pose category set may be a typical pose set. Pose images in the typical pose set may be exhibited, the tester is reminded to make the same poses as those in the pose images, and a pose classification accuracy rate regarding the typical pose is calculated according to manual judging results of whether the pose category value obtained by classifying the test images generated in the way at the pose classifying step S330 is consistent with the exhibited typical pose. Specifically, the counting value POS_N is initialized to be 0, then if it is judged to be consistent, POS_N is added by 1, thereby calculating the pose classification accuracy rate regarding the typical pose

$${Accuracy}^{1} = \frac{Pos\_N}{N} .$$

In addition, all pose images in the typical pose set may be exhibited, the tester is reminded to make any pose other than those in the typical pose set, and whether the pose category value obtained by classifying the test images generated in the way at the pose classifying step S330 is a non-typical pose c0 is manually judged. Specifically, the counting value Neg_N is initialized to be 0, then if it is judged to be c0, Neg_N is added by 1, thereby calculating a pose classification accuracy rate regarding the non-typical pose

$${Accuracy}^{2} = \frac{Neg\_N}{N} .$$

At last, the pose classification accuracy rate is calculated according to the pose classification accuracy rate regarding the typical pose Accuracy¹ and the pose classification accuracy rate regarding the non-typical pose Accuracy², where one exemplary implementation is as follows: the pose classification accuracy rate is Accuracy=μ·Accuracy¹+ν·Accuracy², where μ,ν are representative of weights of two types of accuracy rates, and in the embodiment, μ=0.5, ν=0.5.

At last, at the pose recognition comprehensive evaluating step S350, a comprehensive evaluation score for the human pose recognition technology to be evaluated is calculated, according to the pose classification accuracy rate obtained at the pose classification evaluating step S340. Here, in one exemplary implementation, the pose classification accuracy rate may be regarded directly as the comprehensive evaluation score for the human pose recognition technology to be evaluated.

The methods for evaluating a human pose recognition technology according to the embodiments of the invention have been described above with reference to the drawings, and an apparatus for evaluating a human pose recognition technology will be described with reference to the drawings hereinafter.

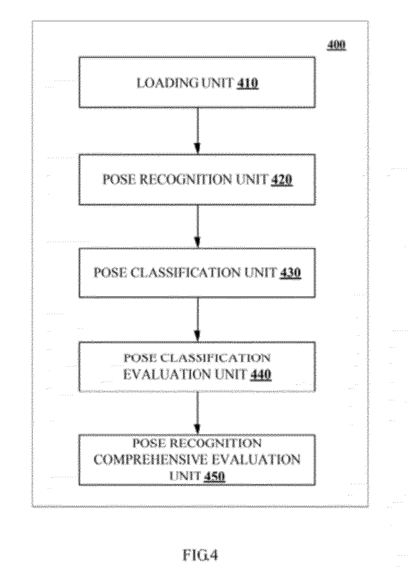

FIG. 4 illustrates a structural block diagram of an apparatus 400 for evaluating a human pose recognition technology according to an embodiment of the invention, where only those parts closely relevant to the invention are shown for the sake of conciseness. In the apparatus 400 for evaluating a human pose recognition technology, the method for evaluating a human pose recognition technology described above with reference to FIG. 1 can be performed.

As shown in FIG. 4, the apparatus 400 for evaluating a human pose recognition technology may comprise a loading unit 410, a pose recognition unit 420, a pose classification unit 430, a pose classification evaluation unit 440, and a pose recognition comprehensive evaluation unit 450.

Where, the loading unit 410 may be configured to load a pose recognition module with the human pose recognition technology to be evaluated. The pose recognition unit 420 may be configured to recognize a human pose for each test image in a test image set using the pose recognition module so as to obtain pose data for each test image. The pose classification unit 430 may be configured to classify the pose data for each test image obtained by the pose recognition unit 420 in terms of a predetermined pose category set composed of a plurality of predetermined pose categories so as to obtain a pose category value for each test image. The pose classification evaluation unit 440 may be configured to calculate a pose classification accuracy rate by comparing the pose category value for each test image obtained by the pose classification unit 430 with a corresponding pose category true value. The pose recognition comprehensive evaluation unit 450 may be configured to calculate a comprehensive evaluation score for the human pose recognition technology to be evaluated, according to the pose classification accuracy rate calculated by the pose classification evaluation unit 440.

Preferably, the apparatus 400 for evaluating a human pose recognition technology may further comprise a pose data evaluation unit (not shown) configured to calculate pose recognition accuracy rate according to the pose data for each test image obtained at the pose recognition unit 420 and the corresponding pose data true value, and the pose recognition comprehensive evaluation unit 450 may calculate the comprehensive evaluation score for the human pose recognition technology to be evaluated according to the pose classification accuracy rate and the pose recognition accuracy rate.

In one exemplary implementation, the pose classification unit 430 may further include a distance calculating sub-unit configured to calculate distances between the pose data for each test image and respective predetermined pose categories in the predetermined pose category set; and category determining sub-unit configured to, if a minimum value of the distances is larger than a predetermined threshold, determine the category value for the pose data as non-predetermined-pose-category, otherwise determine it as a predetermined pose category corresponding to the minimum value of the distances.

How the functions of respective composition units of the apparatus 400 for evaluating the human pose recognition technology can be implemented will become clear through reading the description of corresponding processes given above, thus the details of which are omitted herein.

It shall be indicated herein that the structure of the apparatus 400 for evaluating the human pose recognition technology shown in FIG. 4 is merely exemplary, and those skilled in the art may make modifications to the structural block diagram as shown in FIG. 4 as required.

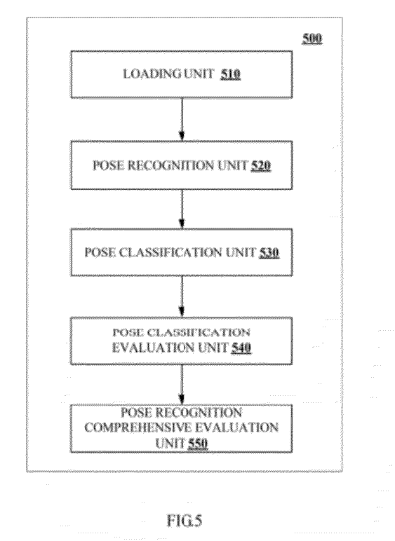

FIG. 5 illustrates structural block diagram of an apparatus 500 for evaluating a human pose recognition technology according to another embodiment of the invention, where only those parts closely relevant to the invention are shown for the sake of conciseness. In the apparatus 500 for evaluating a human pose recognition technology, the method for evaluating a human pose recognition technology described above with reference to FIG. 3 can be performed.

As shown in FIG. 5, the apparatus 500 for evaluating a human pose recognition technology may include a loading unit 510, a pose recognition unit 520, a pose classification unit 530, a pose classification evaluation unit 540, a pose recognition comprehensive evaluation unit 550.

Where, the loading unit 510 may be configured to load a pose recognition module with the human pose recognition technology to be evaluated; the pose recognition unit 520 may be configured to recognize a human pose for each test image in a test image set using the pose recognition module so as to obtain pose data for each test image; the pose classification unit 530 may be configured to classify the pose data for each test image obtained by the pose recognition unit 520 in terms of a predetermined pose category set composed of a plurality of predetermined pose categories so as to obtain a pose category value for each test image; the pose classification evaluation unit 540 may be configured to calculate a pose classification accuracy rate according to manual judging results of whether the pose category value for each test image obtained by the pose classification unit 530 is correct; and the pose recognition comprehensive evaluation unit 550 may be configured to calculate a comprehensive evaluation score for the human pose recognition technology, according to the pose classification accuracy rate obtained by the pose classification evaluation unit 540.

In one exemplary implementation, the pose classification unit 530 may further include a distance calculating sub-unit configured to calculate distances between the pose data for each test image and respective predetermined pose categories in the predetermined pose category set; and category determining sub-unit configured to, if a minimum value of the distances is larger than a predetermined threshold, determine the category value for the pose data as non-predetermined-pose-category, otherwise determine it as a predetermined pose category corresponding to the minimum value of the distances.

In one exemplary implementation, the pose classification evaluation unit 540 may further include a first accuracy rate calculating sub-unit configured to, when the test image contains a human pose made by a tester in terms of a predetermined pose category in the predetermined pose category set, calculate a pose classification accuracy rate regarding the predetermined pose category according to manual judging results of whether the pose category value for the test image obtained in the pose classification unit 530 is consistent with the predetermined pose category; a first accuracy rate calculating sub-unit configured to, when the test image contains a human pose other than those in the predetermined pose category set made by the tester, calculate a pose classification accuracy rate regarding a non-predetermined-pose-category according to manual judging results of whether the pose category value for the test image obtained in the pose classification unit 530 is the non-predetermined-pose-category; and a pose classification accuracy rate calculating sub-unit configured to calculate pose classification accuracy rate according to the pose classification accuracy rate regarding the predetermined pose category and the pose classification accuracy rate regarding the non-predetermined-pose-category.

How the functions of respective composition units of the apparatus 500 for evaluating the human pose recognition technology can be implemented will become clear through reading the description of corresponding processes given above, thus the details of which are omitted herein.

It shall be indicated herein that the structure of the apparatus 500 for evaluating the human pose recognition technology shown in FIG. 5 is merely exemplary, and those skilled in the art may make modifications to the structural block diagram as shown in FIG. 5 as required.

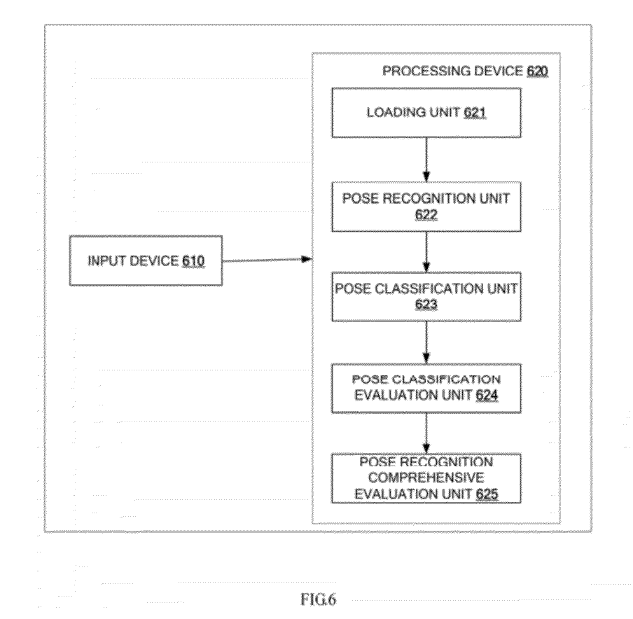

FIG. 6 illustrates a structural block diagram of a computer system 600 for evaluating a human pose recognition technology according to another embodiment of the invention, where only those parts closely relevant to the invention are shown for the sake of conciseness. The computer system 600 for evaluating a human pose recognition technology may be implemented by a general purpose computer system or a special computer system. In the computer system 600 for evaluating a human pose recognition technology, the method for evaluating a human pose recognition technology described above with reference to FIG. 1 can be performed.

As shown in FIG. 6, the computer system 600 for evaluating a human pose recognition technology may include an input device 610 and a processing device 620. The input device 610 may be configured to input test image set, and the processing device 620 may be coupled to the input device 610 and may include a loading unit 621, a pose recognition unit 622, a pose classification unit 623, a pose classification evaluation unit 624, a pose recognition comprehensive evaluation unit 625.

Where, the loading unit 621 may be configured to load a pose recognition module with the human pose recognition technology to be evaluated. The pose recognition unit 622 may be configured to recognize a human pose for each test image in the test image set using the pose recognition module so as to obtain pose data for each test image. The pose classification unit 623 may be configured to classify the pose data for each test image obtained by the pose recognition unit 622 in terms of a predetermined pose category set composed of a plurality of predetermined pose categories so as to obtain a pose category value for each test image. The pose classification evaluation unit 624 may be configured to calculate a pose classification accuracy rate by comparing the pose category value for each test image obtained by the pose classification unit 623 with a corresponding pose category true value. The pose recognition comprehensive evaluation unit 625 may be configured to calculate a comprehensive evaluation score for the human pose recognition technology to be evaluated, according to the pose classification accuracy rate calculated by the pose classification evaluation unit 624.

How the functions of respective composition units of the computer system 600 for evaluating the human pose recognition technology can be implemented will become clear through reading the description of corresponding processes given above, thus the details of which are omitted herein.

It shall be indicated herein that the structure of the computer system 600 for evaluating the human pose recognition technology shown in FIG. 6 is merely exemplary, and those skilled in the art may make modifications to the structural block diagram as shown in FIG. 6 as required.

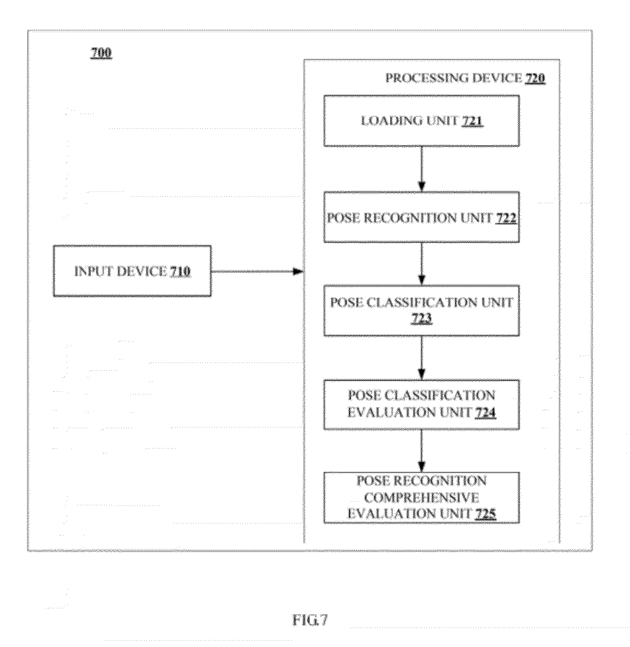

FIG. 7 illustrates a structural block diagram of a computer system 700 for evaluating a human pose recognition technology according to another embodiment of the invention, where only those parts closely relevant to the invention are shown for the sake of conciseness. The computer system 700 for evaluating a human pose recognition technology may be implemented by a general purpose computer system or a special computer system. In the computer system 700 for evaluating a human pose recognition technology, the method for evaluating a human pose recognition technology described above with reference to FIG. 3 can be performed.

As shown in FIG. 7, the computer system 700 for evaluating a human pose recognition technology may include an input device 710 and a processing device 720. The input device 710 may be configured to input test image set, and the processing device 720 may be coupled to the input device 710 and may include a loading unit 721, a pose recognition unit 722, a pose classification unit 723, a pose classification evaluation unit 724, a pose recognition comprehensive evaluation unit 725.

Where, the loading unit 721 may be configured to load a pose recognition module with the human pose recognition technology to be evaluated; the pose recognition unit 722 may be configured to recognize a human pose for each test image in the test image set using the pose recognition module so as to obtain pose data for each test image; the pose classification unit 723 may be configured to classify the pose data for each test image obtained by the pose recognition unit 722 in terms of a predetermined pose category set composed of a plurality of predetermined pose categories so as to obtain a pose category value for each test image; the pose classification evaluation unit 724 may be configured to calculate a pose classification accuracy rate according to manual judging results of whether the pose category value for each test image obtained by the pose classification unit 723 is correct; and the pose recognition comprehensive evaluation unit 725 may be configured to calculate a comprehensive evaluation score for the human pose recognition technology, according to the pose classification accuracy rate obtained by the pose classification evaluation unit 724.

How the functions of respective composition units of the computer system 700 for evaluating the human pose recognition technology can be implemented will become clear through reading the description of corresponding processes given above, thus the details of which are omitted herein.

It shall be indicated herein that the structure of the computer system 700 for evaluating a pose recognition technology shown in FIG. 7 is merely exemplary, and those skilled in the art may make modifications to the structural block diagram as shown in FIG. 7 as required.

The basic principles of the present invention have been described in combination with specific embodiments above, however, it shall be noted that for those skilled in the art, it can be understood that all or any step or component of the method and apparatus of the present invention may be implemented by hardware, firmware, software or combinations thereof in any computing apparatus (including a processor, a storage medium and the like) or a network of computing apparatuses, which can be realized by those skilled in the art by utilizing their basic programming skills after reading the description of the invention

Therefore, the object of the present invention may also be achieved by running a program or a set of programs on any computing apparatuses. The computing apparatuses may be well-known general-purpose apparatuses. Therefore, the object of the present invention may also be achieved simply by providing a program product containing program codes implementing the method or apparatus. That is, such a program product constitutes the present invention, and also a storage medium storing such a program product constitutes the present invention. Obviously, the storage medium may be any well-known storage medium or any storage medium to be developed in the future.

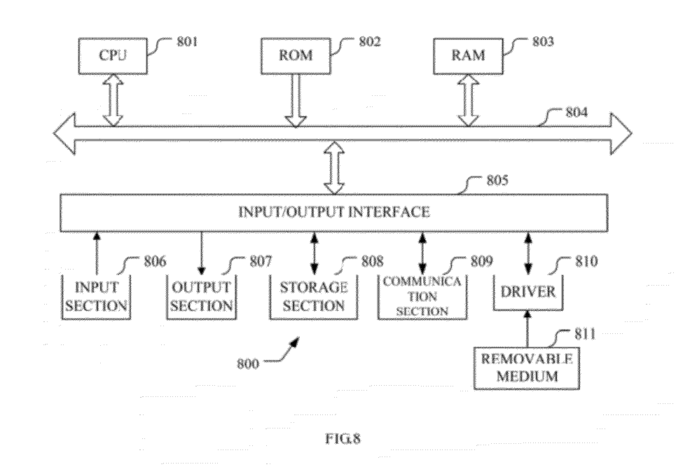

In a case that the embodiments of the invention are implemented by software and/or firmware, the programs constituting the software are installed from a storage medium or a network into a computer with a dedicated hardware structure (for example, a general-purpose computer 800 as shown in FIG. 8), which is capable of carrying out various functions and the like when installed with various programs.

In FIG. 8, a central processing unit (CPU) 801 executes various processes in accordance with programs stored in a Read Only Memory (ROM) 802 or programs loaded into a Random Access Memory (RAM) 803 from a storage section 808. Data required for the CPU 801 to execute the various processes and the like is also stored in RAM 803 as required. The CPU 801, the ROM 802 and the RAM 803 are connected to one another via a bus 804. An Input/output interface 805 is also connected to the bus 804.

The following components are connected to the input/output interface 805: input section 806 including a keyboard, a mouse and the like; an output section 807 including a display such as a cathode ray tube (CRT), a liquid crystal display (LCD) and the like, and a speakers and so on; the storage section 808 including hard drives and the like; and a communication section 809 including a network interface cards such as a LAN cards, a modem and so on. The communication section 809 performs communication process via the network such as Internet.

A driver 810 is also connected to the input/output interface 805 as required. A removable medium 811, such as a magnetic disk, an optical disk, a magneto optical disk, a semiconductor memory, and so on, is mounted onto the driver 810 as required, so that the computer program read therefrom is installed into the storage section 808 as required.

In a case that the above series of processes are implemented by software, the program constituting the software is installed from a network such as Internet or a storage medium such as the removable medium 811.

Those skilled in the art shall understand that this storage medium is not limited to the removable medium 811 in which a program is stored and which is distributed separately from the apparatus so as to provide the program to the user as shown in FIG. 8. Examples of the removable medium 811 include the magnetic disk (including floppy disk (registered trade mark)), the optical disk (including compact disk-read only memory (CD-ROM) and digital versatile disk (DVD)), the magneto optical disk (including mini disk (MD) (registered trade mark)) and the semiconductor memory. Alternatively, the storage medium may be the ROM 802, the hard disk contained in the storage section 808 or the like, in which a program is stored and which is distributed to the user together with the apparatus containing it.

It shall also be noted that obviously each component or each step may be decomposed and/or recombined in the apparatus and method of the present invention. These decompositions and/or re-combinations shall be considered as equivalent schemes of the present invention. Also, the steps of performing the above series of processes may be naturally performed chronologically in an order of description but not necessarily. Some steps may be performed in parallel or independently from one another.

Although the invention and advantages thereof have been described in detail herein, it shall be understood that various changes, replacements and modifications may be made by one skilled in the art without departing from the spirit and scope of the invention. Furthermore, the terms “comprise”, “include” or any other variation thereof are intended to cover a non-exclusive inclusion, so that a process, method, article, or apparatus that comprises a list of elements includes not only those elements but also other elements not explicitly listed or inherent to such process, method, article, or apparatus. Unless further defined, a sentence “comprises a/an . . . ” which defines an element does not preclude the existence of additional identical element(s) in the process, method, article, or apparatus that comprises the element.

What is claimed is:

1. A method for evaluating a human pose recognition technology, using a processor, the method comprising:
a loading step of loading a pose recognition module with the human pose recognition technology to be evaluated;
a pose recognizing step of recognizing a human pose for each test image in a test image set using the pose recognition module, so as to obtain pose data for each test image;
a pose classifying step of classifying the pose data for each test image obtained in the pose recognizing step in terms of a predetermined pose category set composed of a plurality of predetermined pose categories, so as to obtain a pose category value for each test image;
a pose classification evaluating step of calculating a pose classification accuracy rate by comparing the pose category value for each test image obtained in the pose classifying step with a corresponding pose category true value; and
a pose recognition comprehensive evaluating step of calculating a comprehensive evaluation score for the human pose recognition technology, according to the pose classification accuracy rate calculated in the pose classification evaluating step.

2. The method for evaluating a human pose recognition technology according to claim 1, wherein the loading step further comprises, in a case that an interface of the human pose recognition technology is inconsistent with a predetermined interface of the pose recognition module, encapsulating the human pose recognition technology into the pose recognition module with the predetermined interface.

3. The method for evaluating a human pose recognition technology according to claim 1, further comprising a pose data evaluating step of calculating a pose recognition accuracy rate according to the pose data for each test image obtained in the pose recognizing step and a corresponding pose data true value, and
wherein the pose recognition comprehensive evaluating step further comprises calculating the comprehensive evaluation score for the human pose recognition technology according to the pose classification accuracy rate and the pose recognition accuracy rate.

4. The method for evaluating a human pose recognition technology according to claim 1, wherein the pose data for the test image is an XY two-dimensional image coordinate value, an XYZ three-dimensional Cartesian coordinate value, or an angular value of a three-dimensional polar coordinate.

5. The method for evaluating a human pose recognition technology according to claim 1, wherein the pose classifying step further comprises:
calculating distances between the pose data and respective predetermined pose categories in the predetermined pose category set; and
if a minimum value of the distances is larger than a predetermined threshold, determining the category value for the pose data as non-predetermined-pose-category, otherwise determining it as a predetermined pose category corresponding to the minimum value of the distances.

6. The method for evaluating a human pose recognition technology according to claim 1, wherein the predetermined pose category set comprises a predetermined number of arbitrary human poses or a predetermined number of typical human poses.

7. A method for evaluating a human pose recognition technology, using a processor, the method comprising:
a loading step of loading a pose recognition module with the human pose recognition technology to be evaluated;
a pose recognizing step of recognizing a human pose for each test image in a test image set using the pose recognition module so as to obtain pose data for each test image;
a pose classifying step of classifying the pose data for each test image obtained in the pose recognizing step in terms of a predetermined pose category set composed of a plurality of predetermined pose categories so as to obtain a pose category value for each test image;
a pose classification evaluating step of calculating a pose classification accuracy rate according to manual judging results of whether the pose category value for each test image obtained in the pose classifying step is correct; and
a pose recognition comprehensive evaluating step of calculating a comprehensive evaluation score for the human pose recognition technology, according to the pose classification accuracy rate obtained in the pose classification evaluating step.

8. The method for evaluating a human pose recognition technology according to claim 7, wherein the loading step further comprises, in a case that an interface of the human pose recognition technology is inconsistent with a predetermined interface of the pose recognition module, encapsulating the human pose recognition technology into the pose recognition module with the predetermined interface.

9. The method for evaluating a human pose recognition technology according to claim 7, wherein the pose data for the test image is an XY two-dimensional image coordinate value, an XYZ three-dimensional Cartesian coordinate value, or an angular value of a three-dimensional polar coordinate.

10. The method for evaluating a human pose recognition technology according to claim 7, wherein the pose classifying step further comprises:
calculating distances between the pose data and respective predetermined pose categories in the predetermined pose category set; and
if a minimum value of the distances is larger than a predetermined threshold, determining the category value for the pose data as a non-predetermined-pose-category, otherwise determining it as a predetermined pose category corresponding to the minimum value of the distances.

11. The method for evaluating a human pose recognition technology according to claim 7, wherein the pose classification evaluating step further comprises:
when the test image contains a human pose made by a tester in terms of a predetermined pose category in the predetermined pose category set, calculating a pose classification accuracy rate regarding the predetermined pose category according to manual judging results of whether the pose category value for the test image obtained in the pose classifying step is consistent with the predetermined pose category, and when the test image contains a human pose other than the predetermined pose category set made by the tester, calculating a pose classification accuracy rate regarding a non-predetermined-pose-category according to manual judging results of whether the pose category value for the test image obtained in the pose classifying step is the non-predetermined-pose-category; and
calculating the pose classification accuracy rate according to the pose classification accuracy rate regarding the predetermined pose categories and the pose classification accuracy rate regarding the non-predetermined-pose-category.

12. The method for evaluating a human pose recognition technology according to claim 7, wherein the predetermined pose category set comprises a predetermined number of typical human poses.

13. An apparatus for evaluating a human pose recognition technology comprising:
a loading unit configured to load a pose recognition module with the human pose recognition technology to be evaluated;
a pose recognition unit configured to recognize a human pose for each test image in a test image set using the pose recognition module so as to obtain pose data for each test image;
a pose classification unit configured to classify the pose data for each test image obtained by the pose recognition unit in terms of a predetermined pose category set composed of a plurality of predetermined pose categories so as to obtain a pose category value for each test image;
a pose classification evaluation unit configured to calculate a pose classification accuracy rate by comparing the pose category value for each test image obtained by the pose classification unit with a corresponding pose category true value; and
a pose recognition comprehensive evaluation unit configured to calculate a comprehensive evaluation score for the human pose recognition technology, according to the pose classification accuracy rate calculated by the pose classification evaluation unit.

14. An apparatus for evaluating a human pose recognition technology comprising:
a loading unit configured to load a pose recognition module with the human pose recognition technology to be evaluated;
a pose recognition unit configured to recognize a human pose for each test image in a test image set using the pose recognition module so as to obtain pose data for each test image;
a pose classification unit configured to classify the pose data for each test image obtained by the pose recognition unit in terms of a predetermined pose category set composed of a plurality of predetermined pose categories so as to obtain a pose category value for each test image;
a pose classification evaluation unit configured to calculate a pose classification accuracy rate according to manual judging results of whether the pose category value for each test image obtained by the pose classification unit is correct; and
a pose recognition comprehensive evaluation unit configured to calculate a comprehensive evaluation score for the human pose recognition technology, according to the pose classification accuracy rate obtained by the pose classification evaluation unit.

15. A computer system for evaluating a human pose recognition technology comprising:
an input device configured to input a test image set; and
a processing device which is coupled to the input device and comprises:
a loading unit configured to load a pose recognition module constituted by the human pose recognition technology to be evaluated;
a pose recognition unit configured to recognize a human pose for each test image in the test image set using the pose recognition module so as to obtain pose data for each test image;
a pose classification unit configured to classify the pose data for each test image obtained by the pose recognition unit in terms of a predetermined pose category set composed of a plurality of predetermined pose categories so as to obtain a pose category value for each test image;
a pose classification evaluation unit configured to calculate a pose classification accuracy rate by comparing the pose category value for each test image obtained by the pose classification unit with a corresponding pose category true value; and
a pose recognition comprehensive evaluation unit configured to calculate a comprehensive evaluation score for the human pose recognition technology, according to the pose classification accuracy rate calculated by the pose classification evaluation unit.

16. A computer system for evaluating a human pose recognition technology comprising:
an input device configured to input a test image set; and
a process device which is coupled to the input device and comprises:
a loading unit configured to load a pose recognition module constituted by the human pose recognition technology to be evaluated;
a pose recognition unit configured to recognize a human pose for each test image in the test image set using the pose recognition module so as to obtain pose data for each test image;
a pose classification unit configured to classify the pose data for each test image obtained by the pose recognition unit in terms of a predetermined pose category set composed of a plurality of predetermined pose categories so as to obtain a pose category value for each test image;
a pose classification evaluation unit configured to calculate a pose classification accuracy rate according to manual judging results of whether the pose category value for each test image obtained by the pose classification unit is correct; and
a pose recognition comprehensive evaluation unit configured to calculate a comprehensive evaluation score for the human pose recognition technology, according to the pose classification accuracy rate obtained by the pose classification evaluation unit.

17. A program product with machine readable instruction codes stored thereon, which, when being read and executed by a machine, performing a method for evaluating a human pose recognition technology, wherein the method for evaluating a human pose recognition technology comprises:
a loading step of loading a pose recognition module with the human pose recognition technology to be evaluated;
a pose recognizing step of recognizing a human pose for each test image in a test image set using the pose recognition module, so as to obtain pose data for each test image;
a pose classifying step of classifying the pose data for each test image obtained in the pose recognizing step in terms of a predetermined pose category set composed of a plurality of predetermined pose categories, so as to obtain a pose category value for each test image;
a pose classification evaluating step of calculating a pose classification accuracy rate by comparing the pose category value for each test image obtained in the pose classifying step with a corresponding pose category true value; and a pose recognition comprehensive evaluating step of calculating a comprehensive evaluation score for the human pose recognition technology, according to the pose classification accuracy rate calculated in the pose classification evaluating step.

18. A storage medium carrying thereon the program product according to claim 17.

19. A program product with machine readable instruction codes stored thereon, which, when being read and executed by a machine, performing a method for evaluating a human pose recognition technology, wherein the method for evaluating a human pose recognition technology comprises:
a loading step of loading a pose recognition module with the human pose recognition technology to be evaluated;
a pose recognizing step of recognizing a human pose for each test image in a test image set using the pose recognition module so as to obtain pose data for each test image;
a pose classifying step of classifying the pose data for each test image obtained in the pose recognizing step in terms of a predetermined pose category set composed of a plurality of predetermined pose categories so as to obtain a pose category value for each test image;
a pose classification evaluating step of calculating a pose classification accuracy rate according to manual judging results of whether the pose category value for each test image obtained in the pose classifying step is correct; and
a pose recognition comprehensive evaluating step of calculating a comprehensive evaluation score for the human pose recognition technology, according to the pose classification accuracy rate obtained in the pose classification evaluating step.

20. A storage medium carrying thereon the program product according to claim 19.
